(19) United States
(12) Patent Application Publication
(10) Pub. No.: US 2002/0158211 A1
(43) Pub. Date: Oct. 31, 2002

(54) Multi-dimensional fluorescence apparatus and method for rapid and highly sensitive quantitative analysis of mixtures

(75) Inventor: Gregory Gillispie, Fargo, ND (US)

Correspondence Address: Fogg, Slifer & Polglaze, P.A., P.O. Box 581009, Minneapolis, MN, 55458-1009, US

(73) Assignee: Dakota Technologies, Inc.

(21) Appl. No.: 09/835,894

(22) Filed: Apr. 16, 2001

(51) Int. Cl. G01N 21/64

(52) U.S. Cl. 250/458.1

(57) ABSTRACT

An apparatus and method to provide rapid and sensitive quantitative analysis of mixtures by obtaining combined fluorescence wavelength and fluorescence lifetime information, the apparatus having a pulsed light source that induces fluorescence in the sample, the pulses being of a repetitive nature, of short duration, and with very high stability in the pulse energy; a fluorescence wavelength-selector to control the wavelengths of fluorescence photons presented to a photodetector; a digitizer to process the time-dependent electrical signal from the photodetector; and, a memory device that can accept and store a large number of complete fluorescence decay curves from the digitizer each second. The method consists of gathering a wavelength-time matrix, which consists of the digitized fluorescence decay curves for at least two different emission wavelengths or for at least two different excitation wavelengths; and applying a quantitative analysis algorithm that determines a numerical value for the contribution of at least one fluorescent component to the data contained within the wavelength-time matrix.

### TECHNICAL FIELD

The present invention relates generally to the field of fluorometry and, in particular, to an apparatus that rapidly gathers two-dimensional fluorescence and Raman spectroscopic data in the form of a wavelength-time matrix (WTM) and to a method that analyzes the data contained within the wavelength-time matrix to accurately determine the concentration of chemical substances in a mixture.

### BACKGROUND

Instruments designed to gather precise fluorescence intensity data are commonly referred to as fluorometers (also known as fluorimeters). The fluorometers found in high performance liquid chromatography (HPLC), capillary electrophoresis (CE), and automated DNA sequencing instruments are also referred to simply as fluorescence detectors. Conceptually similar fluorescence detectors are employed in microwell plate readers and microarray scanners. Other quantitative analysis applications of fluorometers include counting cells via flow cytometry, determining the amount of DNA or RNA in a sample, measuring enzyme activity, and determining concentrations of hydrocarbons or chlorophyll in water.

Fluorometric apparatuses can be differentiated by the nature of the sample, how the sample is presented to the fluorometer, and the type of fluorescence data that is gathered. In order to fully comprehend our invention and its significance, one must recognize and understand the strengths and weaknesses of the many known variations of fluorometers. At a minimum, every fluorometer incorporates an excitation light source that serves to induce fluorescence in the sample, a means to isolate only those fluorescence photons with a specified wavelength range, and a photodetector that converts the fluorescence light flux within the selected wavelength range to an analog electrical signal; many fluorometers have provision for converting the analog electrical signal to a digitized representation that can be read visually or stored for subsequent data analysis.

The process of fluorescence is initiated when molecules in the sample absorb photons from the light source. The energy that is carried by the excitation photons transfers to the molecules, thereby creating a population of electronically excited molecules. The molecules cannot remain in these excited states indefinitely owing to several possible de-excitation pathways, one of which is photon emission (fluorescence). Owing to certain vibrational relaxation and internal conversion processes that occur between the act of photon absorption (excitation) and photon emission (fluorescence), the average wavelength of the emitted photons is invariably longer than the excitation wavelength that was used to create the excited states via photoabsorption. Within a few picoseconds of the time an excited state molecule is created, it relaxes to the first excited singlet state and it is from this state that the fluorescence occurs. The average residence time of the molecule in the first excited singlet state in usually on the order of 0.1-100 nanoseconds. The shape of the fluorescence spectrum (but not the total intensity) for any particular compound is nearly the same regardless of the choice of excitation wavelength. Likewise, the shape of the excitation spectrum (but not the total intensity) of any particular compound is nearly the same regardless of the choice of wavelength at which the emission is monitored.

Many different excitation sources can supply the more or less monochromatic incident beam of light that is needed to excite (induce) fluorescence in the sample. Some excitation light sources, including tungsten or quartz-halogen lamps, xenon arc lamps, and xenon flashlamps, emit photons over such a broad range of wavelengths so as to require that an interference filter, monochromator, or other wavelength-selector be interposed between the excitation light source and the sample. The primary purpose of the excitation wavelength-selector is to prevent scattered excitation photons whose wavelength is the same as the fluorescence signal of interest from entering the detection system. The output of medium or high pressure xenon arc lamps and xenon flashlamps covers from the vacuum ultraviolet (wavelengths shorter than 200 nm) through the ultraviolet and visible regions and into the near-infrared; thus, essentially any desired wavelength can be obtained by appropriate choice of the excitation wavelength selector, albeit at the price of having to discard 99% or more of the photons emerging from the excitation light source. Light emitting diodes (LEDs) provide photons in comparatively narrower wavelength ranges, 50-100 nm, which eases the task for wavelength filtering their output. Inexpensive LEDs that span the wavelength range from approximately 360 nm into the near-infrared are commercially available.

Laser excitation sources can be highly advantageous for fluorometer applications because their output is so highly monochromatic and the laser light can easily be directed to and focused on the desired sample location. The laser sources that are found in nearly all automated DNA analyzers and most microarray readers generally provide photons in a single, very narrow wavelength range. In order to retain at least a portion of the valuable information that is inherent in the dependence of the fluorescence intensity on excitation wavelength, such instruments may incorporate several fixed wavelength laser sources, although this increases complexity, cost, and measurement time. Tunable lasers or optical parametric oscillators (OPOs) are coherent sources whose output wavelength is continuously variable, but they are also generally large and expensive.

The fluorescence intensity can be monitored within a single emission wavelength range, at several discrete emission wavelengths, or over a continuous range of wavelengths. Instruments that employ dielectric interference filters or glass cut-off filters to select the emission monitoring wavelengths are generally referred to as fluorometers or fluorimeters. The operator may be required to select and install a different filter in the instrument every time the wavelength at which the emission is monitored is changed. Versions with several filters installed in a rotatable filter wheel or on a filter slide, which could be either manually controlled or attached to a motor, are more convenient. Monochromators are very flexible and versatile instruments for wavelength selection. Adjusting the position of a grating or prism within the monochromator allows continuous variation of the passband wavelength. The width of the passband is similarly adjustable through control of the entrance and exit slit widths. Fluorescence measurement instruments that incorporate scanning monochromators for continuous variation of the emission wavelength or both the excitation and emission wavelength are generally referred to as spectrofluorometers or spectrofluorimeters. Yet another option is to use an array detector such as a charge-coupled device (CCD) camera to collect the entire fluorescence spectrum at once. In this case, the monochromator used to disperse (spatially separate) the fluorescence is commonly referred to as a spectrograph. Well-known procedures can be applied to correct the experimental emission spectrum and the excitation spectrum for the wavelength dependence of the measurement system. The corrected spectra then represent fundamental fluorescence properties of the molecules, although these properties may exhibit some dependence on the molecular environment; e.g., the fluorescence spectrum could shift in wavelength if the polarity of the solvent is varied. The practice and principles of fluorescence spectroscopy are described in many textbooks and reference books.

Fluorescence lifetime is another molecular property that is less affected by details of the measurement system than is the case for the spectra, and in many cases no correction is required at all. For example, the fluorescence lifetime is unaffected if the experimental determination is repeated after the light flux directed onto the sample is reduced with a neutral density filter, after a change in excitation wavelength, or if the pulse repetition frequency of the light source is varied. The excited state persistence time for a population of identically prepared molecules is statistically distributed, but the decay of the collective excited state population follows so-called first order kinetics or exponential decay. The lifetime is the time interval over which the excited state population falls to 1/e=36.8% of its initial population. The excited state lifetime is related to the rate constants for all process that deactivate the excited state, but it is commonly referred to as the fluorescence lifetime because fluorescence is by far the most convenient way to follow the changes in excited state population.

Only limited fluorescence lifetime information cannot be gained if the intensity of the excitation beam directed on to the sample is more or less constant. One approach to obtaining lifetime information is to temporally modulate the intensity of the excitation light, usually in a sinusoidal pattern. The emission response of the sample necessarily has the same modulation frequency as the excitation. However, the inherent time lag between the excitation and emission processes induces a phase shift that is mathematically related to the fluorescence lifetime. Such techniques are commonly referred to as frequency domain spectroscopy.

A conceptually simpler approach is to excite the fluorescence with a light pulse of short duration and to measure the temporal pattern of the subsequent fluorescence. The entire fluorescence decay curve can be measured following a single laser excitation pulse with a digital oscilloscope or transient digitizer, whose function is to track the output of a photomultiplier tube or other photodetector at closely-spaced time intervals. A plot of fluorescence intensity vs. time interval expressed relative to the time at which the excited state population is generated is commonly referred to as a fluorescence decay curve; a digitized representation of a transient signal as a function of time is also commonly referred to as a waveform or profile. In the ideal case that the time duration (pulse width) of the excitation pulse is much shorter than the fluorescence decay time, the lifetime can be determined from a plot of In Iₜ vs. t where Iₜ is fluorescence intensity at time t relative to the laser pulse. Many mathematical deconvolution techniques are available for situations in which the excitation pulse duration is not infinitesimally short compared to the fluorescence lifetime. Deconvolution techniques require that the intensity be measured as a function of time for both the excitation pulse and the subsequent fluorescence pulse. Apart from a relatively uninteresting multiplicative factor, the mathematical relationship between the fluorescence and excitation waveforms involves a single parameter, namely the fluorescence lifetime. Each deconvolution procedure has the same goal, namely to determine the value of the lifetime that gives the best fit between the observed and predicted fluorescence decay curves.

The note above that the fluorescence lifetime is independent of the emission monitoring wavelength is true if there is only one type of emitting species, but it is not necessarily true for mixtures. The apparent fluorescence lifetime will depend on the excitation or fluorescence wavelength if the sample contains multiple emitting species with different lifetimes and different excitation and emission spectra In such cases, one expects to observe bi-exponential or multi-exponential decay. The invariance of the fluorescence lifetime to excitation or emission wavelength is a test of sample purity, just as is the invariance of the excitation spectrun to emission monitoring wavelength and the invariance of the emission spectrum to excitation wavelength. The mathematical data processing techniques, including deconvolution, are readily generalized to account for multiple emitting species.

The traditional way to gather the fluorescence decay curve (and the laser excitation pulse shape, if needed for deconvolution) is via time-correlated single photon counting (TCSPC). In TCSPC the sample is repetitively excited and a histogram of the time interval between when the sample is excited and when the first fluorescence photon is detected is generated. The histogram is functionally equivalent to the fluorescence decay curve that is generated if the entire fluorescence decay profile is measured with a transient digitizer. The TCSPC technique is considered advantageous because the data contained within the histogram follow so-called Poisson statistics. On the other hand, in order to attain the condition of Poisson statistics, the measurement conditions must be arranged so that an actual datum (one point in the histogram) is collected on no more than 1 or 2 percent of the laser pulses. Thus, data collection is a lengthy and inefficient process.

Fluorometry often provides higher measurement sensitivity and specificity, greater ease of operation, faster measurement time, or lower instrumentation cost in comparison to other instrumental techniques. Fluorescence spectroscopy is inherently sensitive because the signals of interest are measured against a low (ideally zero) background signal. Absorption spectroscopy, in contrast, is less sensitive when operating near the limit of detection or limit of quantitation because a very small decrease in a large light signal must be determined. The unique combination of excitation spectrum, emission spectrum, and lifetime possessed by each fluorescent compound provides the specificity.

The fluorescent signal intensity depends, inter alia, on the flux of excitation photons within the sample volume and the number of fluorophores within that volume. Other factors that influence the total fluorescence intensity are the wavelength-dependent responses of the wavelength analyzer and the photodetector, the optics used to deliver the excitation light to the sample, the optics used to deliver a portion of the emitted light to the wavelength analyzer in front of the photodetector; and the specific geometrical arrangement of the light source, excitation optics, collection optics, and wavelength analyzer. The fluorescence intensity thus depends on inherent spectroscopic properties of the potentially fluorescent molecules (fluorophores), on the concentration of fluorophores, and on properties of the measurement system itself.

The procedures for characterizing the measurement system properties are tedious and time consuming. Therefore, for purposes of quantitative analysis one generally compares the fluorescence intensity of the sample to the fluorescence intensities of reference or standard samples whose concentrations are known. If the sample consists of a fluid solution, the concentration is usually expressed as a mass per unit volume. For fluorescent species arrayed on a surface, the amount would likely be expressed in terms of mass per unit area. Therefore, fluorescence induced in a sample makes it possible to identify if a fluorescent compound is present in a sample (qualitative analysis) and, if so, to determine its concentration or amount (quantitative analysis).

If it is known that the sample fluorescence intensity arises from a single, known compound, implementation of the quantitative analysis techniques and interpretation of the data are straightforward. The quality and value of the analysis is compromised if the sample contains unknown or unsuspected fluorescent species and nearly every sample could be considered to fall within this category to some degree. Fluorescence is ideally a zero background technique, as was stated above, but a certain amount of background signal is inevitably present. The sources of the background signal are many, including stray excitation light at the desired fluorescence monitoring wavelength, fluorescence from impurities in the sample, and interfering fluorescence of the sample container.

A high data acquisition rate is essential for most chromatographic analyses, microplate or microarray scanning, in vivo optical diagnostics, and many other procedures in which either the sample composition is rapidly changing or many different samples must be tested. How to account for background signal and how to sense when more than one species is contributing to the fluorescence signal is a common theme and challenge. Confirmatory chemical analysis by techniques that rely on discrete sampling are so time consuming as to be completely incompatible with the desire for rapid measurement rate.

A primitive approach that has some value for chromatography is to examine the pattern of intensities at contiguous elution times. The fluorescence intensity of a species as it elutes is expected to vary smoothly from zero to a maximum and then return to zero. Various mathematical formulas have been postulated to fit the shapes of the peaks, which are referred to by such terms as normal (Gaussian) or log-normal; sufficiently large deviations from the characteristic shape for compounds eluting at comparable time intervals after the sample was injected could signify the presence of two or more fluorophores whose peaks are overlapping. As long as the sample concentrations are low enough so that energy transfer and quenching processes are negligible, the total fluorescence intensity is closely approximated by the sum of contributions from the individual fluorescent compounds in the sample. The sample conditions that apply to high performance liquid chromatography (HPLC) and capillary electrophoresis (CE), for DNA sequencing analysis, and for many other fluorescence procedures satisfy the dilute sample condition requirement. Thus, one can attempt to resolve the overlapping peaks, but procedures that attempt to do so solely on the basis of lineshape are notoriously inaccurate. Nor does such an analysis provide any information on the chemical identity of an interfering fluorophore. Background subtraction techniques that assume that the background signal is either constant or slowly varying are similarly applied and have similar limitations.

There is precedent for using spectroscopic data in more elaborate fashion to test for peak purity. For example, photodiode array (PDA) detectors that can measure a full absorption spectrum, as opposed to absorbance at a single wavelength, are well known in chromatography. Peaks can be tentatively assigned and peak purity assessed by comparing the measured spectrum at a given elution time to the entries in a database of known standard spectra. A peak purity index is derived from the degree of overlap of the unknown spectrum with its closest match in the database. However, if the peak purity index is low, suggesting that there is more than one emitting component in the sample, the problem of how to apportion the total spectrum into its components, including background signal, remains. Thus, PDA detectors are used more to avoid misassignments than it is to increase the amount of information that can be gained in a given amount of experiment time.

Owing to the cumbersome nature of the peak purity testing procedures and the lack of easily applied algorithms that can accurately resolve overlapping peaks into the contributions of individual species, great effort is undertaken to arrange the chromatographic separation conditions to reduce the likelihood that more than one kind of species is in the detector volume at a given time. Unfortunately, these conditions, which require careful optimization and adjustment of variables such as the solvent's eluting strength and the flow rate, invariably result in much longer elution times and diminished productivity.

In fact, virtually all fluorescence detectors used in chromatography, microplate readers, microarray readers, quantitative PCR apparatuses, etc., rely on measuring with a single excitation wavelength and a single emission wavelength for each sample composition or location because this is the only approach compatible with the high data acquisition rates. One must recognize that the datum from such a measurement is simply a number, regardless of the units in which it is expressed, e.g., current, voltage, counts, etc. The data are dimensionally zero-order in mathematical terms. It should be apparent that unambiguously decomposing this number into the separate contributions of different fluorophores or a fluorophore and background is impossible. From the standpoint of purity, it is similarly impossible mathematically to assign a purity index to the individual measurement.

The only fluorescence detectors that routinely collect a full fluorescence spectrum at closely spaced time intervals, e.g., less than one second, are found in very expensive automated DNA sequencers. The most sophisticated of these sequencers collect the entire fluorescence spectrum with a CCD camera positioned at the exit focal plane of a spectrograph, but most of the spectral information is discarded in the data processing step. Other versions make measurements at a multiplicity of wavelengths (typically four because four dyes are used in one-lane DNA sequencing) via rapid rotation of a filter wheel or the use of dichroic filters to direct the light in various wavelength ranges to multiple detectors. Certain microplate and microarray readers allow either the emission monochromator or excitation monochromator to be scanned to generate a fill spectrum, but these modes are too slow for most applications.

Fluorescence potentially offers many different options (none of which are routinely used) for confidence testing analogous to the use of a PDA in absorbance detection for HPLC. The analogy would be closest if a complete fluorescence spectrum were measured at each elution time in the chromatogram, which could be accomplished with an intensified photodiode array (IPDA), also referred to as a gated optical multichannel analyzer (OMA). Alternatively, a CCD camera detector with elements binned along an axis perpendicular to the spectral dispersion direction could be used to collect a full fluorescence spectrum. Although such implementations have been described in the literature, their use has been limited to research purposes because of high cost and other reasons.

There is ample evidence in the literature and widespread agreement among researchers that multidimensional fluorescence analyses yield much more information in terms of both specificity and sensitivity than corresponding one-dimensional spectral techniques. However, the use of multidimensional techniques has largely been limited to research investigations because: 1) The rate at which the data are gathered and processed is generally far too slow for any practical commercial application; 2) Technologies that could achieve the requisite speed are prohibitively expensive; and 3) Robust and rapid data analysis methodologies are not available to utilize the information that is inherently contained in the data. Attempts at commercialization of the technology and methodology have been hampered by these impediments.

Fluorescence is unique among spectroscopic techniques in its capability for multidimensional data wherein fluorescence intensity data are measured along at least two of the three important spectroscopic coordinates, which are excitation wavelength, emission wavelength, and fluorescence decay time. The most familiar multi-dimensional fluorescence representation is that of an excitation-emission matrix (EEM). EEMs are most commonly generated as a series of emission spectra acquired at different excitation wavelengths. Alternatively and equivalently, a series of excitation spectra can be gathered for different emission monitoring wavelengths and will yield the same result. By their very nature, EEMs contain more information than is available in either the excitation or the emission spectrum alone. The potential benefits of EEMs for purposes of diagnosing tumors via endoscopy or identifying sources of oil spills have long been recognized. However, the practical use of EEMs has been severely circumscribed by the lengthy and tedious manner in which they must be acquired.

At least two groups have proposed speeding the process by which EEMs are collected using a multiple wavelength excitation source based on Raman shifting, but these are complicated instruments requiring separate pairs of optical fibers for every excitation wavelength and an expensive CCD camera. Moreover, the Raman shifting process leads to large fluctuations in the laser excitation pulse energy and degraded signal to noise. A company has recently introduced a commercial fluorimeter that incorporates an old technique known as video fluorometry, allowing the collection of an EEM in as short a time as one second. However, the fast measurement time comes at a ten-fold or greater sacrifice in measurement sensitivity and the question of how to analyze the data remains.

Decomposing the sample's total emission or excitation spectrum into contributions from its various constituents is difficult. If a pulsed excitation source of sufficiently short duration is employed, one can collect second-order data in the form of a wavelength-time matrix (WTM). A WTM in its simplest incarnation consists of fluorescence decay curves measured at a series of emission or excitation wavelengths. The information can be assembled into a two-dimensional data array in which the columns represent different wavelengths (either excitation or emission), and the rows represent different time increments relative to the time at which fluorescence was excited with a short duration laser pulse. Although WTMs have received far less attention in the literature than EEMs, they possess certain advantages owing to the manner in which the fluorescence decay curves can be mathematically related to the laser excitation waveforms.

If EEMs or WTMs are collected in sequence mode, i.e., one emission spectrum or one fluorescence decay curve at a time, it is very important that conditions be held as constant as possible during the entire sequence to avoid distortion. Two likely sources of distortion are drifts in the laser power or sample degradation. For example, if the laser intensity steadily dropped during the collection of the EEM, then there will be a systematic error across the EEM. The same type of behavior results if photochemistry or other processes change the concentration of fluorophores in the sample during the course of the data collection. These problems are avoided if the entire EEM or WTM can be collected simultaneously.

Heretofore, instruments used for generating WVTMs have been too slow and unstable to be useful for many analytical processes, such as analysis of samples whose properties change rapidly in time and space, including analysis of flowing fluids or rapidly scanning sample surfaces. The reasons for this situation are many and varied, but include shot-to-shot laser fluctuation, slow repetition rates and expense of the lasers, inability of digitizers to keep pace with lasers having faster repetition rates, lack of methodology for handling the volume of data generated, and lack of robust algorithms for analysis of the data.

Our invention solves numerous problems related to the pervasive and challenging situation in which the sample contains multiple fluorescent compounds.

### SUMMARY

The embodiments of the present invention and its uses and advantages, which are many and varied, will be understood by reading and studying the following specification. The invention addresses two major limitations of existing technology that were identified in the background section, namely that: (a) instruments that can individually obtain fluorescence wavelength or fluorescence lifetime information from samples lack adequate specificity for analysis of mixtures; and (b) instruments that can overcome the specificity limitation by acquiring combined fluorescence wavelength and fluorescence lifetime information are too slow for practical use as detectors in high performance liquid chromatography, capillary electrophoresis, DNA sequencing, or microplate reading. These and many other applications require measurement times less than one second either because the sample is rapidly changing composition as it passes through the detector or because a very large number of sample locations must be studied and analyzed in a short period of time.

The various embodiments of our invention, which include an apparatus and method, have the common features that are now enumerated. Embodiments of the apparatus incorporate a fluorescence excitation light source that emits pulses at a high pulse repetition frequency, each of the pulses having substantially the same pulse energy in excess of 1 microjoule with the pulse duration being less than 2 nanoseconds when measured at full width half maximum. A portion of the fluorescence emitted from the sample is directed to a wavelength-selector that outputs fluorescence photons within selected wavelength ranges. The photons that are output by the wavelength-selector are directed to a photodetector, which converts the transient stream of fluorescence photons into a transient analog electrical signal that is commonly referred to as a fluorescence decay curve. The chosen photodetector could be a photomultiplier tube, a photodiode, or an avalanche photodiode, depending on the size of the photon flux. A preamplifier could be used to increase the amplitude of the output from a photodiode or avalanche photodiode. The analog fluorescence decay curve is sampled at closely spaced time intervals with a digital oscilloscope or transient digitizer in order to generate a digital representation of the fluorescence decay curve. The digitized fluorescence decay curve generated in connection with each excitation light pulse is transferred to a memory or data recorder for subsequent data analysis, the transfer ideally being completed fast enough so that the digitizer and data recorder are ready to receive and process the information induced by the next fluorescence excitation light pulse. Such digitized fluorescence decay curves are rapidly generated and stored in the memory of the data recorder in the form of a wavelength-time matrix (WTM), the WTM consisting of a plurality of fluorescence decay curves acquired for various fluorescence emission or fluorescence excitation wavelengths. The fluorescence decay curves in a single WTM may be contracted into a one-dimensional array for purposes of efficient storage or mathematical processing. The process of generating and storing the WTMs is repeated for various elution times in chromatography, for various wells in a microwell plate, etc. The WTMs are mathematically analyzed via a computer program that incorporates an algorithm to determine quantitatively the contributions of at least one fluorescent species to the WTM. Various algorithms are possible and distinguishable depending on whether WTMs for any target species are known. If the WTMs for the species of interest are known a priori through calibration or other means, their contributions to the experimental WTMs are easily determined via a non-negative least squares fit. Alternatively, the experimental WTMs can be decomposed with no a priori assumptions other than the number of species that contribute to the WTM. One very important benefit of the mathematical processing is that it allows the removal of background signal that otherwise confuses the analysis.

Various scenarios by which many WTMs, each corresponding to a different sample composition or sample position, are gathered and stored for the mathematical analysis are envisioned. In high performance liquid chromatography, capillary electrophoresis, or DNA sequencing, the sample composition is continuously varying as it flows through the detector region. The WTMs must be collected fast enough so that the change in sample composition from one WTM to the next is small. In microplate reading, which is widely used in biomedical research, the common plate formats are 96, 384, or 1536 samples per plate. High throughput screening places a premium on minimizing the time needed to collect the data for each of the sample positions on the plate. Our invention can be employed as the plate is moved in sequence to position the individual samples in the excitation light beam. Alternatively, the light from the excitation beam can be directed with a scanning mirror to the various sample positions on the plate. Another use of the invention is to rapidly assess a surface for the presence of contamination, which could be oil and grease, food residue, microbiological species, etc., to examine growths on skin for evidence of cancer, to assess the surface of fruits and vegetables for ripeness or other quality indicators, etc. Just as in the microplate reading application, the sample whose surface is to be assessed could be moved in order to position various portions of the surface in the excitation light beam. Alternatively, the excitation light beam could be swept or scanned with a mirror arrangement over the surface. In yet another implementation, an operator could use a handheld fiber optic probe to direct the fluorescence excitation light to sample locations as desired. In this case, the fiber optic probe would have provision to automatically return a portion of the fluorescence signal to the wavelength selector. In addition, the measurement time or number of wavelengths in the WTM could be adjusted to improve the quality of the WTM for sample locations of particular interest. The implementations by which either separate fiber optics are used to deliver the fluorescence excitation light and collect the fluorescence emission or a single fiber optic is used to both deliver the excitation and collect the fluorescence are so well known in the literature as to not require elaboration here. However, it should be noted that another distinct application of fiber optic probes that is relevant to our invention involves inserting a fiber optic probe in the esophagus, colon, arteries, and other tube-like orifices in the search for abnormal cells or cancer. A related application would involve inserting a needle-like miniaturized fiber optic probe directly into the skin, the brain or other organ, pockets between the gum line and teeth, etc.

It should be clear to all who are knowledgeable in fluorescence measurement technology and its use for the applications just described that there is a need to complete each measurement as quickly as possible without unduly compromising the sensitivity and specificity of the detection. Measurement along the fluorescence decay time coordinate requires a pulsed excitation source. Pulsed excitation sources are generally not favored for fluorescence measurements because their amplitude fluctuation is too high. The concept of generating a WTM with a pulsed laser excitation source, such as a Q-switched laser, was first described at least 20 years ago, and it was similarly described how the WTM might be analyzed. However, implementations are even rarer than is the case for EEMs for reasons of instrument complexity and long measurement time. Pulsed laser options that are nominally suitable for our intended applications are solid-state Nd:YAG and similar actively Q-switched lasers such as Nd:YAG or excimer lasers. In addition to the aforementioned cost and size limitations, the solid state lasers are limited by relatively low pulse-repetition frequency (generally less than 100 pulses per second), long pulse duration, and poor shot-to-shot intensity variation, which is typically 5% root-mean-square or greater. Yet another problem of these excitation sources is that their output generally contains many longitudinal modes, which results in their temporal output exhibiting multiple intensity maxima The contribution of the maxima vary randomly from one laser shot to the next.

Embodiments of our invention solve these problems. The various possible embodiments are carefully summarized in the detailed description. The main variations are summarized here. The preferred excitation source is a diode-pumped, passively Q-switched laser with pulse repetition frequency greater than 1000 pulses per second and pulse duration less than one nanosecond. Owing to the very short cavity lengths in these lasers, their output is single mode longitudinally and hence, the intensity output is temporally smooth. Heretofore, these lasers have been limited in their pulse energy, particularly in the ultraviolet, but higher energy versions are now available. The very high intensity stability of these lasers makes it possible to use a wide variety of wavelength selectors and is key to our invention. The WTM is a series of fluorescence decay curves for different emission wavelengths or excitation wavelengths; only the former is known heretofore because no one has presented a practical way to vary the excitation wavelength as wavelength-time matrix is collected. Amplitude fluctuation of the laser excitation source as the fluorescence decay data are collected at the various wavelengths is a serious source of error, necessitating the averaging of the decay curves for many laser shots. A previous invention of ours taught how fiber optic delay lines could be implemented for collection of fluorescence decay curves at several emission wavelengths simultaneously, thereby reducing the WTM measurement time to as low as 1 second. A concomitant advantage of the simultaneous measurement is that the amplitude fluctuations affect the fluorescence decay curves equally at all wavelengths. Embodiments of the present invention, which optimally improve the shot-to-shot stability from greater than 5% rms to better than 1% rms, yield a 25-fold or greater reduction in measurement time to obtain equivalent signal-to-noise (S/N) ratio; note that S/N depends on the square root of the number of replicate measurements that are averaged. The S/N advantage is so profound that it makes it feasible to use simpler wavelength selectors to generate one emission or excitation wavelength at a time. The options for the wavelength-selector include a filter wheel or filter slide with separate filters, a linear variable filter with continuously graded passband wavelength across its surface, an acousto-optic tunable filter, or a rapid scanning monochromator. Of these the linear variable filter is the simplest. The fiber optic delay line will always provide the greatest measurement speed owing to its multiplex advantage.

Embodiments of our invention also recognize that at the envisioned high pulse repetition frequencies, most digital oscilloscopes and transient digitizers cannot keep up with the stream of information. Commercial digital storage oscilloscopes generally cannot accept a new trigger more often than 100 times per second. Information is thus lost if the pulse repetition frequency is greater than 100 pulses per second. Another limitation of digital storage oscilloscopes for the intended applications is that the information associated with many laser excitation shots will be lost during the time the oscilloscope is transferring the averaged fluorescence decay curves to an archival memory location, most probably on a personal computer. Hundreds or even thousands of laser pulses could occur during the time it takes for one such data transfer. The preferred implementation of our invention will have the transient digitizer directly in communication with the bus of the personal computer so that each individual waveform can be written to memory even if the laser pulse repetition frequency exceeds 10,000 pulses per second.

In summary, then, we have developed the first practical multidimensional fluorescence detector and have indicated many different ways it can be used to rapidly gather fluorescence data that can be processed to yield quantitative information in environmental analysis, chromatography, mutation analysis, DNA sequencing, assessing cleanliness of surfaces, etc.

### BRIEF DESCRIPTION OF THE DRAWINGS

FIG. 1 is a block diagram illustrating an embodiment of the present invention.

FIGS. 2a and 2b are block diagrams respectively illustrating different embodiments of a pulsed light source according to the teachings of the present invention.

FIGS. 3,4, and 5 respectively illustrate different embodiments of a fluorescence wavelength-selector according to the teachings of the present invention.

FIG. 6 is a graphical representation of an exemplary set of wavelength-time matrices according to the teachings of the present invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

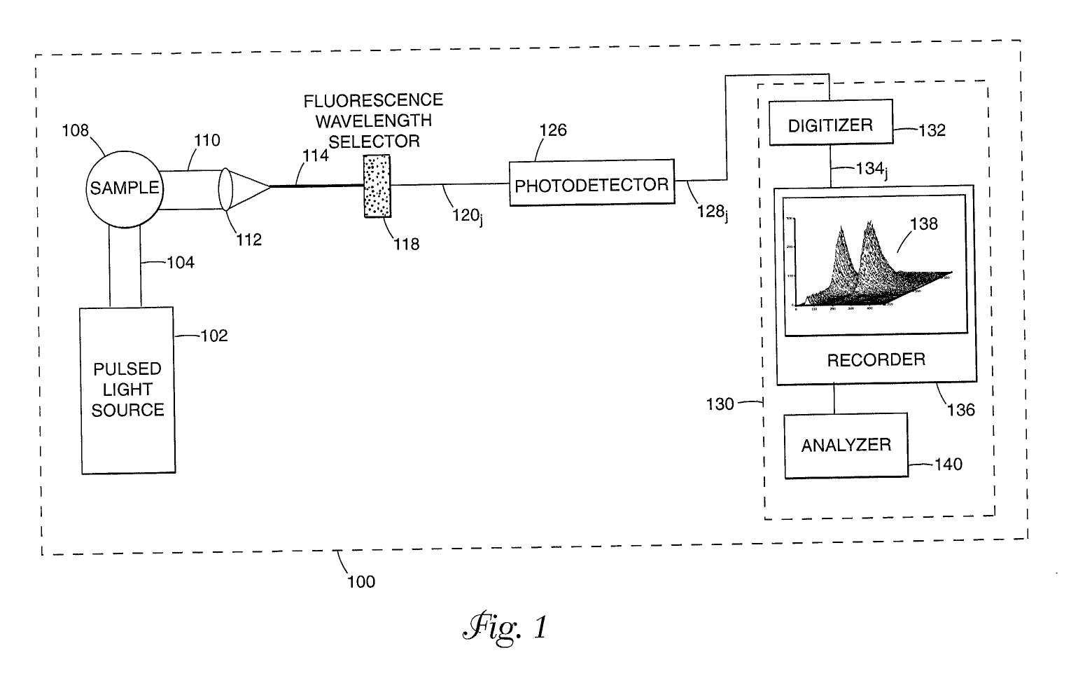

Apparatus 100, shown in FIG. 1, demonstrates an embodiment of the present invention. Apparatus 100 includes pulsed light source 102, which emits beam 104 as a repetitive stream of light pulses. The wavelength of beam 104 is suitable to excite fluorescence in a sample. The duration of the light pulses, as measured by the fall temporal width of the pulses at half the maximum intensity, is less than 1.1 nanoseconds. The root-mean-square deviation in the pulse energy, commonly referred to as the shot-to-shot fluctuation, is no greater than three percent for pulsed light source 102. In one embodiment, pulsed light source 102 has a shot-to-shot fluctuation no greater than one percent. Pulsed light source 102 is adapted to emit 100 or more pulses each second.

In one embodiment, pulsed light source 102 is a single-mode pulsed laser, e.g., the passively Q-switched, solid-state Nd: YAG laser manufactured by Litton Airtron Synoptics (Model ML-00024). Excitation light source 102 can be adapted to output light as the second harmonic (532 nm), third harmonic (355 nm), or fourth harmonic (266 nm) with the aid of appropriate non-linear optical materials whose use is familiar to those of ordinary skill in the art. Single mode in this context refers to the longitudinal mode structure, single mode being desirable because the intensity of the light pulse is temporally smooth, i.e., the intensity monotonically increases to a maximum value, then monotonically decreases without exhibiting secondary intensity maxima or minima.

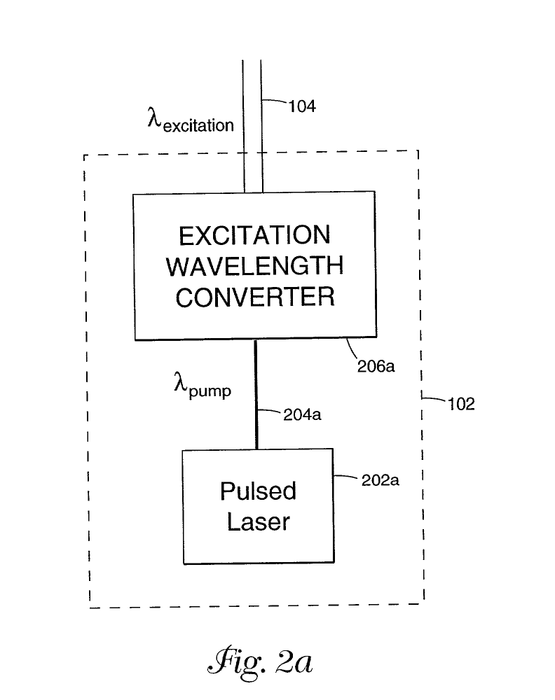

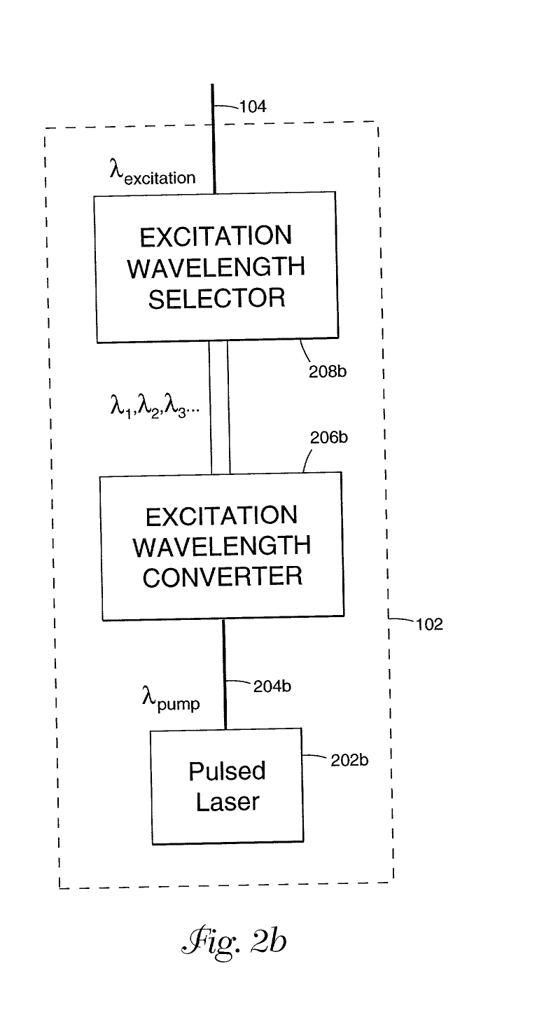

In other embodiments, pulsed light source 102 is adapted to selectively output excitation beam 104 at various wavelengths that can be selected by the user. In the embodiment shown in FIG. 2a, pulsed light source 102 includes input pulsed laser 202a that directs pump beam 204a to excitation wavelength-converter 206a. Excitation wavelength-converter 206a receives the photons in beam 204a at wavelength λₚᵤₘₚ and converts a fraction of the received photons to photons at a different wavelength λ_{excitation}. Various wavelengths are selectively output by selecting different values for λ_{excitation} at excitation wavelength-converter 206a. Excitation wavelength-converter 206 can be a dye laser, a solid-state vibronic laser, an optical parametric oscillator, or the like. Input pulsed laser 202a can be a single-mode pulsed laser, e.g., the passively Q-switched, solid-state Nd: YAG laser manufactured by Litton Airtron Synoptics (Model ML-00024).

In another embodiment, demonstrated in FIG. 2b, pulsed light source 102 includes input pulsed laser 202b, excitation wavelength-converter 206b, and excitation wavelength-selector 208b. Excitation wavelength-converter 206b receives pump beam 204b from input pulsed laser 202b and generates photons simultaneously at multiple wavelengths, λ₁,λ₂, λ₃, etc. when pumped by pump beam 204b(or a portion of pump beam 204b). Excitation wavelength-converter 206b transmits the photons at the multiple wavelengths to excitation wavelength-selector 208b. Excitation wavelength-selector 208b receives the photons at the multiple wavelengths from excitation wavelength-converter 206b and serves to restrict the output to one wavelength (λ_{excutation}) at a time in beam 104.

In one embodiment, excitation wavelength-converter 206b includes a Raman shifting cell for generating photons simultaneously at a number of different wavelengths. The action of wavelength-selector 208b can be accomplished with a prism, a monochromator, a series of filters, or the like. Input pulsed laser 202b can be a single-mode pulsed laser, e.g., the passively Q-switched, solid-state Nd: YAG laser manufactured by Litton Airtron Synoptics (Model ML-00024).

Beam 104 irradiates sample 108, which contains a fluorescent compound or mixture of fluorescence compounds, including, but not limited to, aromatic hydrocarbons, chlorophyll, fluorescent tracer dyes, DNA or RNA molecules reacted with a fluorescent tag, etc. In another embodiment, beam 104 is focused on sample 108 with a lens, a curved mirror, or other optic that serves to concentrate the light beam. Beam 104 irradiates sample 108, causing sample 108 to emit fluorescence beam 110. Fluorescence beam 110 consists of a repetitive stream of fluorescence pulses, one fluorescence pulse being generated for each excitation light pulse that strikes sample 108. Fluorescence beam 110 is directed to fluorescence wavelength selector 118. In one embodiment, the fluorescence beam 110 passes through lens 112 that concentrates fluorescence beam 110 onto fluorescence wavelength selector 118. In another embodiment, fluorescence beam 110 from sample 108 is directed to the fluorescence wavelength selector via an optical fiber 114. In another embodiment, the lens 112 and optical fiber 114 are used together, as demonstrated in FIG. 1.

Fluorescence wavelength-selector 118 receives as an input fluorescence beam 110. Fluorescence wavelength-selector 118 outputs a substantial portion of the input fluorescence that lies within a specified wavelength range as beam 120ⱼ(where j, an index running from 1 to N, labels the various possible emission wavelengths that can be selected). It will be appreciated by those of ordinary skill in the art of fluorescence that stream 120ⱼ comprises fluorescence photons whose wavelengths lie in a range about a center wavelength λⱼ.

In embodiments involving variation of the fluorescence emission wavelength for purposes of generating an emission wavelength-time matrix, fluorescence wavelength-selector 118 sequentially outputs beams 120ⱼ, 120ₖ, etc. at two or more emission wavelengths λⱼ, λₖ, etc. In embodiments where pulsed light source 102 selectively outputs beam 104 at two or more excitation wavelengths for purposes of generating an excitation wavelength-time matrix, fluorescence wavelength-selector 118 outputs stream 120ⱼ at a single wavelength λⱼ.

The specific values of emission wavelengths that are established by the emission wavelength selector 118 are selected per the particular application. For example, in applications involving fluorescent dye molecules deliberately added to the sample, the emission wavelength could be chosen after consideration of the known fluorescence spectra of the dye molecules. It will be appreciated by those of ordinary skill in the art that one might choose a different emission wavelength than the one at which intensity is greatest in order to minimize interference from scattered excitation photons or for other reasons.

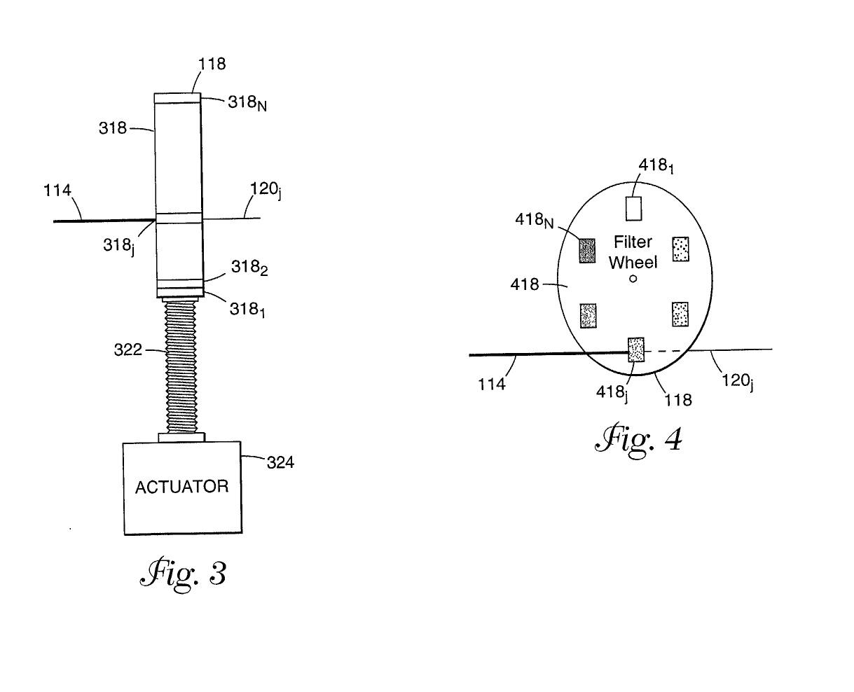

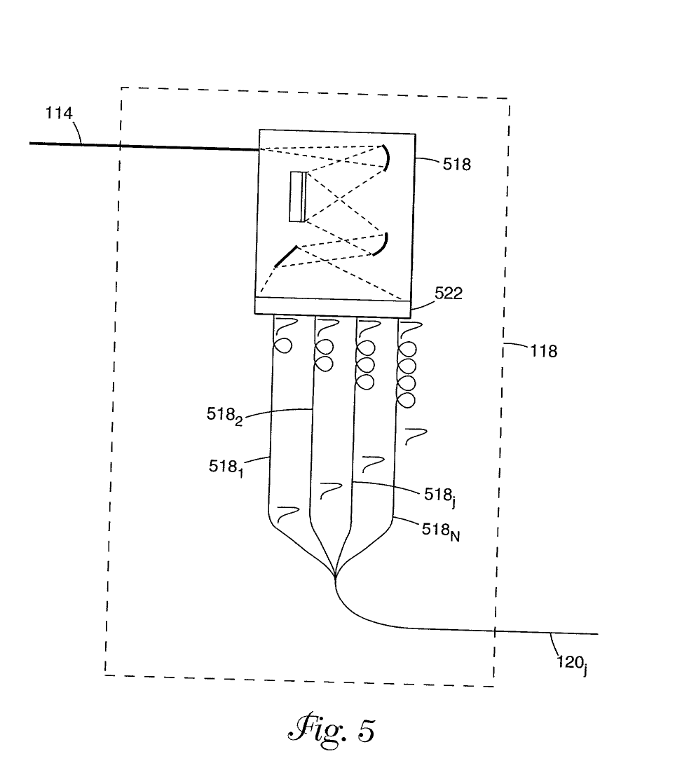

In one embodiment, fluorescence wavelength-selector 118 is a linear variable filter 318, as demonstrated in FIG. 3. The wavelength passband of linear variable filter 318 is continuously graded along its length, but it functions as if it contained a multitude of segments 318ⱼ, j=1 to N. Each segment 318ⱼ allows fluorescence at substantially a single corresponding wavelength λⱼ to pass through it, thereby creating wavelength-selected fluorescence beam 120ⱼ. To select fluorescence at a wavelength λⱼ to be output from linear variable filter 318, linear variable filter 318 is positioned so that the appropriate section of the linear variable filter intercepts beam 110. In one embodiment, linear variable filter 318 is actuated using lead-screw 322 driven by actuator 324, e.g., a stepper motor, as shown in FIG. 3. In another embodiment, linear variable filter 318 passes wavelengths in the range of 380 to 720 nanometers.

In another embodiment, a control circuit that receives inputs from a computer program controls actuator 324. In this embodiment, the user selects a set of wavelengths, and actuator 324 positions linear variable filter 318 SO that the selected wavelengths pass through the appropriate regions of linear variable filter 318. In another embodiment, the control circuit also receives inputs from light source 102. In this embodiment, the user selects the desired wavelengths and the number of light pulses for which data are to be collected at each wavelength. After the selected number of pulses is passed through the appropriate region of linear variable filter 318, actuator 324 positions the linear variable filter to isolate fluorescence light in a different desired wavelength range. This is repeated for each of the selected wavelengths.

In other embodiments, fluorescence wavelength-selector 118 includes a set of discrete filters. In one embodiment, the set of discrete filters 418₁ to 418_{N} is arranged in a holder that is able to position a desired discrete filter to select fluorescence photons emitted by the sample at a substantially single, corresponding wavelength. For example, in one embodiment, the discrete filters 418₁ to 418_{N} are arranged on filter wheel 418, as demonstrated in FIG. 4. In one embodiment, the filters are chosen on the basis of the expected wavelength distribution of the total fluorescence emission. To select fluorescence at a wavelength λⱼ to be output from filter wheel 418, filter wheel 418 is actuated so that discrete filter 418ⱼ receives a portion of the pulsed fluorescence contained in stream 110. The fluorescence having a wavelength λⱼ passes through discrete filter 418ⱼ and is output as stream 120ⱼ. In one embodiment, filter wheel 418 is actuated using a stepper motor.

In another embodiment, fluorescence wavelength-selector 118 is an acousto-optic tunable filter. In another embodiment, fluorescence wavelength-selector 118 is a monochromator.

In another embodiment, fluorescence wavelength-selector 118 comprises spectrograph 518 and optical fibers 518₁ to 518_{N}, as shown in FIG. 5. Each of optical fibers 518₁ to 518_{N} is coupled to transmit fluorescence photons at a substantially single wavelength from the position of the exit focal plane 522 of spectrograph 518 to photodetector 126 (see FIG. 1). Optical fibers 518₁ to 518_{N} respectively output signals 120₁ to 120_{N}, which contain photons at the desired wavelengths λ₁ to λ_{N}.

Each of optical fibers 518₁ to 518_{N} has a different length in order to temporally separate the arrival of photon signals 120ⱼ at photodetector 126. For example, photon signal 120, reaches the photodetector 126 earlier in time than photon signal 120₂ because optical fiber 518₁ is shorter than optical fiber 518₂. It is in this way that the fluorescence wavelength is selected. Details of using a spectrograph and optical fibers for selecting wavelengths of fluorescence are described in U.S. Pat. No. 5,828,452, entitled SPECTROSCOPIC SYSTEM WITH A SINGLE CONVERTER AND METHOD FOR REMOVING OVERLAP IN TIME OF DIRECTED EMISSIONS, issued on Oct. 27, 1998, which is incorporated herein by reference.

Focusing on the jth wavelength, where j can be any of one or more integer values between 1 and N, photodetector 126 receives beam 120ⱼ as an input from fluorescence wavelength-selector 118, as demonstrated in FIG. 1. Photodetector 126 converts beam 120ⱼ into time-dependent analog electrical signal 128ⱼ and outputs time-dependent analog electrical signal 128ⱼ. In other embodiments, photodetector 126 is one of a photomultiplier tube, a photodiode, and an avalanche photodiode.

Signal processor 130 receives time-dependent analog electrical signal 128ⱼ as an input and determines a numerical value for the contribution of at least one component of sample 108 based on time-dependent electrical signal 128ⱼ. More specifically, digitizer 132 of signal processor 130 receives analog time-dependent electrical signal 128ⱼ as an input and converts analog time-dependent electrical signal 128ⱼ into digitized signal 134ⱼ. Digitizer 132 can be any analog-to-digital converter having at least eight-bit resolution and at least a 200 MHz analog bandwidth that digitizes time-dependent electrical signal 128ⱼ at a digitization rate of at least 500 million samples per second, e.g., the COMPUSCOPE 8500 available from Gage Applied, Inc.

In embodiments in which fluorescence wavelength selector 118 outputs a single wavelength at a time, digitized signal 134ⱼ comprises a digitized fluorescence decay curve corresponding to emission wavelength λⱼ. A digitized fluorescence decay curve is acquired for every pulse of pulsed light source 102. In embodiments involving variation of the emission wavelength for purposes of generating an emission wavelength-time matrix, recorder 136 receives digitized fluorescence decay curves 134ⱼ from digitizer 132 for at least two emission wavelengths and outputs an emission wavelength-time matrix. In one embodiment, recorder 136 averages the digital fluorescence decay curves at each j-value (emission wavelength) by summing the digital fluorescence decay curves for multiple laser shots and dividing the summed fluorescence decay curve by the number of laser shots. The output of recorder 136, which then comprises an emission wavelength-time matrix that includes averaged fluorescence decay curves for at least two emission wavelengths, is suitable for subsequent mathematical processing and analysis.

In the embodiment of FIG. 5, digitized signal 134 incorporates the fluorescence decay curves for a series of emission wavelengths λⱼ, the component fluorescence decay curves separated in time from each other by the delays created by light traveling over the optical fibers 518₁ to ⁵¹⁸_{N}. In one embodiment, recorder 136 averages the digital fluorescence decay curves that contain contributions for several emission wavelengths by summing the digital fluorescence decay curves for multiple laser shots and dividing the summed fluorescence decay curve by the number of laser shots. The output of recorder 136 can then be processed to generate an emission wavelength-time matrix that includes averaged fluorescence decay curves for at least two emission wavelengths and is suitable for subsequent mathematical processing and analysis. The means by which the emission wavelength-time matrix is generated by removing the delays imposed by the fiber optic delay line is described U.S. Pat. No. 5,828,452, entitled SPECTROSCOPIC SYSTEM WITH A SINGLE CONVERTER AND METHOD FOR REMOVING OVERLAP IN TIME OF DIRECTED EMISSIONS, issued on Oct. 27, 1998, which is incorporated above by reference. In another embodiment, the digital fluorescence decay curves that contain contributions for several emission wavelengths can be analyzed directly by a basis set method.

In embodiments where pulsed light source 102 selectively outputs beam 104 at two or more excitation wavelengths for purposes of generating an excitation wavelength-time matrix, recorder 136 receives digitized signal 134ⱼ from digitizer 132 at a single emission wavelength λⱼ, and outputs an excitation wavelength-time matrix that includes fluorescence decay curves for at least two excitation wavelengths. In one embodiment, recorder 136 averages the digital fluorescence decay curves at each excitation wavelength by summing the digital fluorescence decay curves for multiple laser shots and dividing the summed fluorescence decay curve by the number of laser shots. The output of recorder 136, which then comprises an excitation wavelength-time matrix that includes averaged fluorescence decay curves for at least two excitation wavelengths, is suitable for subsequent mathematical processing and analysis.

Sample 108 should not be interpreted to mean a substance of invariant composition. The composition and nature of sample 108 could vary in time, as in the case of material eluting from the column in high performance liquid chromatography (HPLC), or as the sample undergoes chemical reaction. In other embodiments, sample 108 actually represents a set of soil samples probed at different depths below the ground-surface, a set of discrete samples residing in the wells of a microplate, a set of various locations on a more or less flat surface, etc. In these cases, a wavelength-time matrix can be acquired and processed for each member of the data set, e.g., wavelength-time matrices are repetitively acquired, each individual wavelength-time matrix being labeled by an index corresponding to various elution times, depths below ground surface, wells in a microplate, position on a surface, etc.

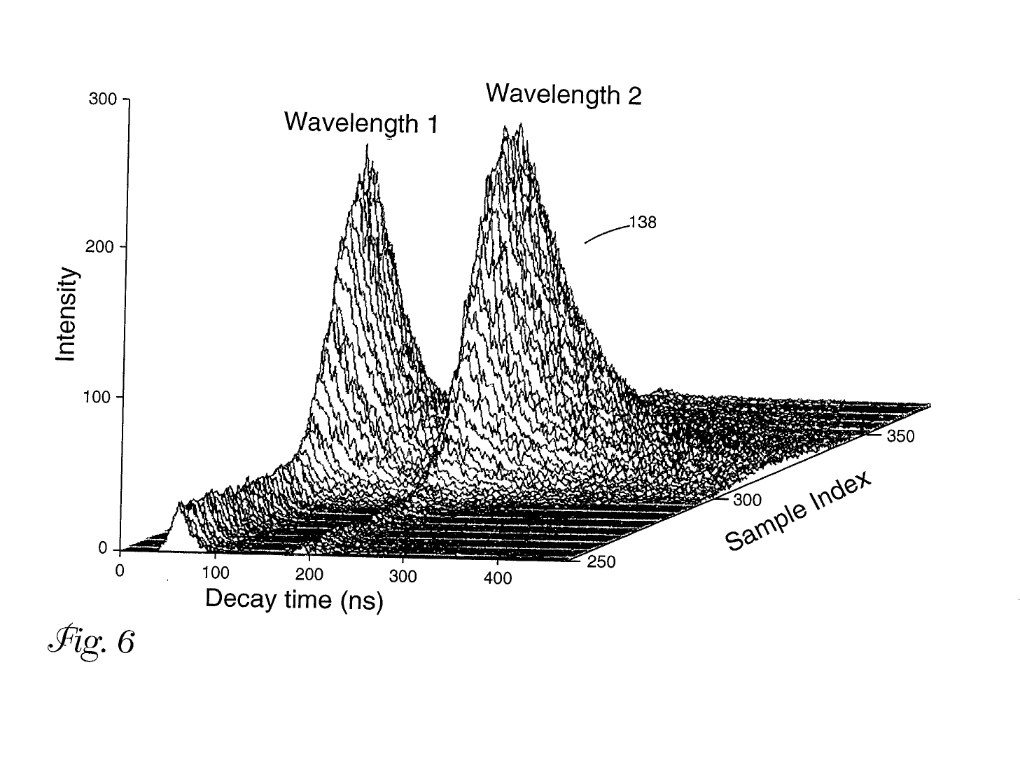

Plot 138, shown in FIGS. 1 and 6, is a graphical representation of an exemplary set of wavelength-time matrices for HPLC. Plot 138 is intended as an example and can be viewed as a graphical representation of an embodiment in which the emission wavelength-time matrix is encoded in a single intensity vs. time record via the use of fiber optic delay lines. The different sample indices correspond to different elution times.

Analyzer 140 of signal processor 130 receives the wavelength-time matrix from the recorder and outputs a numerical value for the contribution of at least one fluorescent component to the data contained within the wavelength-time matrix (excitation or emission). In one embodiment, analyzer 140 is a computer program, e.g., MATLAB, that implements an algorithm, e.g., the SIMPLEX algorithm, to interpret the data contained within the wavelength-time matrix (excitation or emission).

The wavelength-time matrix can be represented as an m×n matrix [D], where m is the number of rows in the matrix and n is the number of columns in the matrix. In one embodiment, m is the number of decay time increments for each fluorescence decay curve and n is the number of emission wavelengths. In another embodiment, m is the number of decay time increments for each fluorescence decay curve and n is the number of excitation wavelengths. For purposes of the analysis, matrix [D] can be represented as a product of two matrices

[D]=[A]×[C] (1)

where [A] is an m×p matrix whose columns contain fluorescence spectra of the p emitting components in sample 108 and [C] is an p×n matrix whose rows contain fluorescence decay curves for the p emitting components. The product representation shown in equation (1) is based on the assumptions of linear detector response and independent response of each component in the sample.

By decomposing matrix [D] into components [A] and [C], analyzer 140 identifies the individual components of sample 108 and constructs representations of their fluorescence spectra and decay kinetics. In one embodiment, analyzer 140 decomposes matrix [D] by constructing a model matrix [D′] as in equation (2)

[D′]=[A′]×[C′] (2)

In one embodiment, analyzer 140 constructs [ C′] row by row using equation (3) below

$${C}_{s , r}^{′} = {\sum }_{q = 1}^{r} {E}_{q} exp ( - ( r - q ) Δ t / {τ}_{s} ) \qquad ( 3 )$$

where q represents the q^{th} digitization interval, E_{q} is the intensity of a pulse of beam 104 at the q^{th} digitization interval, τₛ is the lifetime of the s^{th} component of sample 108, and Δt is the digitization time interval. Analyzer 140 calculates the components [C′] based on a trial set of τₛ values.

Analyzer 140 determines [A′] from

[A′]=[D][C]^{τ}([C′][C′]^{τ})⁻¹ (4)

where superscript T refers to the transpose of the corresponding matrix.

Analyzer 140 determines [D′] from equation (2) using [C′] and [A′]. Analyzer 140 compares [D′] to [D] by computing the sum of the square of the differences between the components of [D′] and the corresponding components of [D] from

$${χ}^{2} = {\sum }_{q = 1}^{m} {\sum }_{r = 1}^{n} {( {D}_{q , r} - {D}_{q , r}^{′} )}^{2} \qquad ( 5 )$$

where D_{q,r} and D_{q,r} are respectively the q-r components of [D] and [D′] Note that the value of χ² depends the trial set of τ^{s} values. Analyzer 140 varies the trial set of τ^{s} values until χ² is minimized.

When χ² is minimized, the corresponding set of τₛ values represents the lifetimes of the respective components of sample 108. Moreover, the [A] matrix corresponding to the minimum value for χ² gives the spectra of the respective components of sample 108 multiplied by scaling factors that are related to the concentrations of the components.

In embodiments where sample 108 is changing, it is convenient and appropriate to collect a series of wavelength-time matrices, one for each discrete sample, elution time, depth, location on a surface, etc. Each element in the series shall be referred to as a sub-sample. The wavelength-time matrix for each sub-sample can be independently analyzed in the fashion described above. However, a given component could be present in many, perhaps even all, of the sub-samples. The fluorescence spectrum and lifetime for a component is not expected to change from one sub-sample to another, but its concentration does.

In one embodiment, wavelength-time matrices are measured for reference samples of known composition. The measured wavelength-time matrices can be represented as a linear combination of the reference wavelength-time matrices with a non-negative least squares fit algorithm.

In another embodiment, analyzer 140 writes each wavelength-time matrix obtained from sample 108 as a single column vector d. In one embodiment, the wavelength-time matrix obtained from sample 108 is an emission wavelength-time matrix. In another embodiment, the wavelength-time matrix obtained from sample 108 is an excitation wavelength-time matrix. Analyzer 140 then expresses column vector d as the product of an unknown column vector c and matrix [B] as in equation (6)

d=c×[B] (6)

In equation (6), matrix [B] is a measured wavelength-time matrix for a set of target compounds.

Each column of matrix [B] is a decay profile of one of the target compounds. Each decay profile is obtained by replacing sample 108 in apparatus 100 with a target compound. Each target compound is either known or suspected to be present in sample 108.

In other embodiments, the first column of [B] is a background profile scaled to an intensity that is comparable to the other columns of [B]. The background profile is chosen by examining the complete data set for wavelength-time matrices of sub-samples that have the lowest intensities. The wavelength-time matrices for these low intensity samples are averaged and the average is taken as the background profile.

Analyzer 140 solves equation (6) to produce a set of coefficients in vector c that indicate how much of each decay profile from [B] is needed to produce the observed decay profile of vector d. This enables the identification of the compounds in sample 108 and their concentration. In one embodiment, analyzer 140 uses a curve fitting procedure to replicate an observed decay profile based on decay profiles for the reference compounds that could be in the mixture. In another embodiment, analyzer 140 uses a non-negative least squares approach to find the values for the vector c. Details of forming matrix [B] and solving equation (6) using a non-negative least squares approach to find the values for the vector c are given in U.S. Pat. No. 5,828,452, entitled SPECTROSCOPIC SYSTEM WITH A SINGLE CONVERTER AND METHOD FOR REMOVING OVERLAP IN TIME OF DIRECTED EMISSIONS, issued on Oct. 27, 1998, which is incorporated above by reference.

### Conclusion

Embodiments of the present invention have been described. The embodiments provide a means of generating second-order data at a level of speed and precision heretofore unavailable.

Although specific embodiments have been illustrated and described in this specification, it will be appreciated by those of ordinary skill in the art that any arrangement that is calculated to achieve the same purpose may be substituted for the specific embodiment shown. This application is intended to cover any adaptations or variations of the present invention.

What is claimed is:

1. An apparatus that provides rapid and sensitive quantitative analysis of a sample by fluorescence, the apparatus comprising:
a repetitively pulsed excitation light source that is directed to the sample to generate pulsed fluorescence in the sample, the light source having a shot-to-shot fluctuation no greater than three percent;
a fluorescence wavelength-selector that receives as an input a portion of the pulsed fluorescence from the sample and that outputs a fraction of the input fluorescence that lies within a specified wavelength range;
a photodetector that receives fluorescence photons within the specified wavelength range as an input from the fluorescence wavelength-selector and outputs a time-dependent electrical signal; and
a signal processor coupled to the photodetector that receives the time-dependent electrical signal as an input and determines a numerical value for the contribution of at least one component of the sample based on the time-dependent electrical signal.

2. The apparatus of claim 1, wherein the signal processor generates fluorescence decay curves from the time-dependent electrical signal and stores the decay curves for at least two different emission wavelengths, and wherein the numerical value is based on the stored decay curves.

3. The apparatus of claim 1, wherein the signal processor comprises:
a digitizer that converts the time-dependent electrical signal into a digitized signal;
a recorder that receives the digitized signal from the digitizer and outputs a wavelength-time matrix that includes fluorescence decay curves for at least two emission wavelengths; and
an analyzer that receives the wavelength-time matrix from the recorder and outputs a numerical value for the contribution of at least one fluorescent component to the data contained within the wavelength-time matrix.

4. The apparatus of claim 1, wherein the duration of the light source pulses is less than 1.1 ns.

5. The apparatus of claim 1, wherein the light source is adapted to emit 100 or more pulses each second.

6. The apparatus of claim 1, wherein the shot-to-shot fluctuation is less than one percent.

7. The apparatus of claim 1, wherein the light source is at least one of a pulsed laser, a pulsed laser whose pulse energy is greater than 1 micro-Joule, a pulsed laser that is passively Q-switched, and a pulsed laser that is single mode.

8. The apparatus of claim 1, wherein the fluorescence wavelength-selector includes a linear variable filter.

9. The apparatus of claim 8, wherein the fluorescence wavelength-selector further comprises an actuator that is coupled to the linear variable filter and-that moves the linear variable filter so as to vary the wavelength of fluorescence transmitted by the linear variable filter within the specified wavelength range.

10. The apparatus of claim 1, wherein the fluorescence wavelength-selector includes a set of discrete filters, each of the discrete filters of the set for transmitting fluorescence photons emitted by the sample at a substantially single, different wavelength.

11. The apparatus of claim 10, wherein the set of discrete filters is arranged in a holder that positions individually each of the discrete filters to select fluorescence photons emitted by the sample in a specified wavelength range.

12. The apparatus of claim 1, wherein the fluorescence wavelength-selector includes one of an acousto-optic tunable filter, a monochromator, and a spectrograph.

13. The apparatus of claim 1, wherein the fluorescence wavelength-selector comprises a spectrograph and a plurality of optical fibers each coupled to transmit fluorescence photons from an exit focal plane of the spectrograph to the photodetector, each fiber transmitting a different wavelength of the specified wavelength range, the fibers having different lengths to temporally separate the arrival of the fluorescence photons of the different wavelengths at the photodetector.

14. The apparatus of claim 1, wherein the photodetector is one of a photomultiplier tube, a photodiode, and an avalanche photodiode.

15. The apparatus of claim 1, wherein the signal processor includes at least one analog-to-digital converter that has at least eight-bit resolution and at least a 200 MHz analog bandwidth, and digitizes the time-dependent electrical signal at a digitization rate of at least 500 million samples per second.

16. The apparatus of claim 15, wherein the signal processor includes a memory device that stores the digitized time-dependent electrical signal as a wavelength time matrix.

17. The apparatus of claim 1, wherein optical elements are used to concentrate the light emitted from the sample onto the fluorescence wavelength-selector.

18. An apparatus that provides rapid and sensitive quantitative analysis of a sample by fluorescence, the apparatus comprising:
a single-mode pulsed laser that is directed to the sample to generate pulsed fluorescence in the sample, the pulsed laser having a shot-to-shot fluctuation no greater than one percent and a pulse energy greater than 1 micro-Joule:
a fluorescence wavelength-selector that receives as an input a portion of the pulsed fluorescence from the sample and that outputs a fraction of the input fluorescence that lies within a specified wavelength range;
a photodetector that receives fluorescence photons within the specified wavelength range as an input from the fluorescence wavelength-selector and outputs a time-dependent electrical signal;
a digitizer coupled to the photodetector that receives the time-dependent electrical signal as an input and that converts the time-dependent electrical signal into a digitized signal;
a recorder that receives the digitized signal from the digitizer and outputs a wavelength-time matrix that includes fluorescence decay curves for at least two emission wavelengths; and
an analyzer that receives the wavelength-time matrix from the recorder and outputs a numerical value for the contribution of at least one fluorescent component to the data contained within the wavelength-time matrix.

19. The apparatus of claim 18, wherein the duration of the laser pulses is less than 1.1 ns.

20. The apparatus of claim 18, wherein the laser emits 100 or more pulses each second.

21. The apparatus of claim 18, wherein the laser is passively Q-switched.

22. The apparatus of claim 18, wherein the fluorescence wavelength-selector includes a linear variable filter.

23. The apparatus of claim 22, wherein the fluorescence wavelength-selector further comprises an actuator that is coupled to the linear variable filter and that moves the linear variable filter so as to vary the wavelength of fluorescence transmitted by the linear variable filter within the specified wavelength range.

24. The apparatus of claim 18, wherein the fluorescence wavelength-selector includes a set of discrete filters, each of the discrete filters of the set for transmitting fluorescence photons emitted by the sample at a substantially single, different wavelength.

25. The apparatus of claim 24, wherein the set of discrete filters is arranged in a holder that positions individually each of the discrete filters to select fluorescence photons emitted by the sample in a specified wavelength range.

26. The apparatus of claim 18, wherein the fluorescence wavelength-selector includes one of an acousto-optic tunable filter, a monochromator, and a spectrograph.

27. The apparatus of claim 18, wherein the fluorescence wavelength-selector comprises a spectrograph and a plurality of optical fibers each coupled to transmit fluorescence photons from an exit focal plane of the spectrograph to the photodetector, each fiber transmitting a different wavelength of the specified wavelength range, the fibers having different lengths to temporally separate the arrival of the fluorescence photons at the different wavelengths at the photodetector.

28. The apparatus of claim 18, wherein the photodetector is one of a photomultiplier tube, a photodiode, and an avalanche photodiode.

29. The apparatus of claim 18, wherein the digitizer includes at least one analog-to-digital converter that has at least eight-bit resolution and at least a 200 MHZ analog bandwidth, and digitizes the time-dependent electrical signal at a digitization rate of at least 500 million samples per second.

30. The apparatus of claim 18, wherein optical elements are used to concentrate the light emitted from the sample onto the fluorescence wavelength-selector.

31. An apparatus that provides rapid and sensitive quantitative analysis of a sample by fluorescence, the apparatus comprising:
a repetitively pulsed excitation light source that is directed to the sample to generate pulsed fluorescence in the sample, the light source adapted to selectively output light pulses at various excitation wavelengths, the light source having a shot-to-shot fluctuation no greater than three percent at any of the excitation wavelengths;
a fluorescence wavelength-selector that receives as an input a portion of the pulsed fluorescence from the sample and that outputs a fraction of the input fluorescence that lies within a specified wavelength range;
a photodetector that receives fluorescence photons within the specified wavelength range as an input from the sample and outputs a time-dependent electrical signal; and
a signal processor coupled to the photodetector that receives the time-dependent electrical signal as an input and determines a numerical value for the contribution of at least one component of the sample based on the time-dependent electrical signal.

32. The apparatus of claim 31, wherein the signal processor generates fluorescence decay curves from the time-dependent electrical signal, stores the decay curves for at least two different excitation wavelengths, and wherein the numerical value is based on the stored decay curves.

33. The apparatus of claim 31, wherein the signal processor comprises:
a digitizer that converts the time-dependent electrical signal into a digitized signal;
a recorder that receives the digitized signal from the digitizer and outputs a wavelength-time matrix that includes fluorescence decay curves for at least two excitation wavelengths; and
an analyzer that receives the wavelength-time matrix from the recorder and outputs a numerical value for the contribution of at least one fluorescent component to the data contained within the wavelength-time matrix.

34. The apparatus of claim 31, wherein the duration of the light source pulses is less than 1.1 ns.

35. The apparatus of claim 31, wherein the light source is adapted to emit 100 or more pulses each second.

36. The apparatus of claim 31, wherein the shot-to-shot fluctuation is less than one percent at any of the excitation wavelengths.

37. The apparatus of claim 31, wherein the light source comprises an input pulsed laser and an excitation wavelength-converter.

38. The apparatus of claim 31, wherein the light source comprises an input pulsed laser, excitation wavelength-converter, and excitation wavelength-selector.

39. The apparatus of claim 31, wherein the fluorescence wavelength-selector includes a linear variable filter.

40. The apparatus of claim 39, wherein the fluorescence wavelength-selector further comprises an actuator that is coupled to the linear variable filter and that moves the linear variable filter so as to vary the wavelength of fluorescence transmitted by the linear variable filter within the specified wavelength range.

41. The apparatus of claim 31, wherein the fluorescence wavelength-selector includes a set of discrete filters, each of the discrete filters of the set for transmitting fluorescence photons emitted by the sample at a substantially single, different wavelength.

42. The apparatus of claim 41, wherein the set of discrete filters is arranged in a holder that positions individually each of the discrete filters to select fluorescence photons emitted by the sample in a specified wavelength range.

43. The apparatus of claim 31, wherein the fluorescence wavelength-selector includes one of an acousto-optic tunable filter, a monochromator, and a spectrograph.

44. The apparatus of claim 31, wherein the fluorescence wavelength-selector comprises a spectrograph and a plurality of optical fibers each coupled to transmit fluorescence photons from an exit focal plane of the spectrograph to the photodetector, each fiber transmitting a different wavelength of the specified wavelength range, the fibers having different lengths to temporally separate the arrival of the fluorescence photons at the different wavelengths at the photodetector.

45. The apparatus of claim 31, wherein the photodetector is one of a photomultiplier tube, a photodiode, and an avalanche photodiode.

46. The apparatus of claim 31, wherein the signal processor includes at least one analog-to-digital converter that has at least eight-bit resolution and at least a 200 MHz analog bandwidth, and digitizes the time-dependent electrical signal at a digitization rate of at least 500 million samples per second.

47. The apparatus of claim 46, wherein the signal processor includes a memory device that stores the digitized time-dependent electrical signal as a wavelength time matrix.

48. The apparatus of claim 31, wherein optical elements are used to concentrate the light emitted from the sample onto the fluorescence wavelength-selector.

49. An apparatus that provides rapid and sensitive quantitative analysis of a sample by fluorescence, the apparatus comprising:
a single-mode input pulsed laser;
an excitation wavelength-converter that receives as an input light pulses from the single-mode input pulsed laser, that is directed to the sample to generate pulsed fluorescence in the sample, and that selectively outputs light pulses at various excitation wavelengths, the light pulses having a shot-to-shot fluctuation no greater than one percent at any of the excitation wavelengths;
a fluorescence wavelength-selector that receives as an input a portion of the pulsed fluorescence from the sample and that outputs a fraction of the input fluorescence that lies within a specified wavelength range;
a photodetector that receives fluorescence photons within the specified wavelength range as an input from the sample and outputs a time-dependent electrical signal;
a digitizer coupled to the photodetector that receives the time-dependent electrical signal as an input and that converts the time-dependent electrical signal into a digitized signal;
a recorder that receives the digitized signal from the digitizer and outputs a wavelength-time matrix that includes fluorescence decay curves for at least two excitation wavelengths; and
an analyzer that receives the wavelength-time matrix from the recorder and outputs a numerical value for the contribution of at least one fluorescent component to the data contained within the wavelength-time matrix.

50. The apparatus of claim 49, wherein the duration of the laser pulses is less than 1.1 ns.

51. The apparatus of claim 49, wherein the single-mode input pulsed laser emits 100 or more pulses each second.

52. The apparatus of claim 49, wherein the single-mode input pulsed laser is passively Q-switched.

53. The apparatus of claim 49, wherein the excitation wavelength-converter receives input light pulses from the single-mode input pulsed laser, generates photons simultaneously at multiple wavelengths, and transmits the photons at the multiple wavelengths to an excitation wavelength-selector, wherein the excitation wavelength-selector selectively restricts the light pulses directed to the sample to one excitation wavelength at a time.

54. The apparatus of claim 49, wherein the fluorescence wavelength-selector includes a linear variable filter.

55. The apparatus of claim 54, wherein the fluorescence wavelength-selector further comprises an actuator that is coupled to the linear variable filter and that moves the linear variable filter so as to vary the wavelength of fluorescence transmitted by the linear variable filter within the specified wavelength range.

56. The apparatus of claim 49, wherein the fluorescence wavelength-selector includes a set of discrete filters, each of the discrete filters of the set for transmitting fluorescence photons emitted by the sample at a substantially single, different wavelength.

57. The apparatus of claim 56, wherein the set of discrete filters is arranged in a holder that positions individually each of the discrete filters to select fluorescence photons emitted by the sample in a specified wavelength range.

58. The apparatus of claim 49, wherein the fluorescence wavelength-selector includes one of an acousto-optic tunable filter, a monochromator, and a spectrograph.

59. The apparatus of claim 49, wherein the fluorescence wavelength-selector comprises a spectrograph and a plurality of optical fibers each coupled to transmit fluorescence photons from an exit focal plane of the spectrograph to the photodetector, each fiber transmitting a different wavelength of the specified wavelength range, the fibers having different lengths to temporally separate the arrival of the fluorescence photons at the different wavelengths at the photodetector.

60. The apparatus of claim 49, wherein the photodetector is one of a photomultiplier tube, a photodiode, and an avalanche photodiode.

61. The apparatus of claim 49, wherein the digitizer includes at least one analog-to-digital converter that has at least eight-bit resolution and at least a 200 MHz analog bandwidth, and digitizes the time-dependent electrical signal at a digitization rate of at least 500 million samples per second.

62. The apparatus of claim 49, wherein optical elements are used to concentrate the light emitted from the sample onto the fluorescence wavelength-selector.

63. A fluorometric method comprising:
irradiating a sample with a plurality of light pulses having a shot-to-shot fluctuation no greater than three percent to generate pulsed fluorescence in the sample;
selecting a portion of the pulsed fluorescence from the sample within a specified wavelength range;
generating a time-dependent electrical signal based on the selected portion of the pulsed fluorescence; and
determining a numerical value for the contribution of at least one component of the sample based on the time-dependent electrical signal.

64. The method of claim 63, wherein determining a numerical value includes generating fluorescence decay curves from the time-dependent electrical signal for at least two different emission wavelengths, wherein the numerical value is determined from the fluorescence decay curves.

65. The method of claim 63, wherein determining a numerical value comprises:
digitizing the time-dependent electrical signal;
recording the digitized time-dependent electrical signal as a wavelength-time matrix that includes fluorescence decay curves for at least two emission wavelengths; and
analyzing the wavelength-time matrix to determine the numerical value, wherein the numerical value represents the contribution of at least one fluorescent component to the data contained within the wavelength-time matrix.

66. A fluorometric method comprising:
irradiating a sample using a repetitively pulsed excitation light source having a shot-to-shot fluctuation no greater than three percent to generate pulsed fluorescence in the sample;
receiving a portion of the pulsed fluorescence from the sample at a fluorescence wavelength-selector;
selecting a fraction of the fluorescence received at the fluorescence wavelength-selector that lies within a specified wavelength range using the fluorescence wavelength-selector and outputting fluorescence photons within the specified wavelength range from fluorescence wavelength-selector;
receiving the fluorescence photons within the specified wavelength range from the fluorescence wavelength-selector at a photodetector;
converting the fluorescence photons received by the photodetector into a time-dependent electrical signal using the photodetector and outputting the time-dependent electrical signal from the photodetector;
receiving the time-dependent electrical signal from the photodetector at a signal processor; and
determining a numerical value for the contribution of at least one component of the sample based on the time-dependent electrical signal using the signal processor.

67. The method of claim 66, wherein determining a numerical value includes generating fluorescence decay curves from the time-dependent electrical signal and storing the decay curves for at least two different emission wavelengths, wherein the numerical value is determined from the stored decay curves.

68. The method of claim 66, wherein determining a numerical value comprises:
digitizing the time-dependent electrical signal;
recording the digitized time-dependent electrical signal as a wavelength-time matrix that includes fluorescence decay curves for at least two emission wavelengths; and
analyzing the wavelength-time matrix to determine the numerical value, wherein the numerical value represents the contribution of at least one fluorescent component to the data contained within the wavelength-time matrix.

69. A fluorometric method comprising:
irradiating a sample using a single-mode pulsed laser having a shot-to-shot fluctuation no greater than one percent and a pulse energy greater than 1 micro-Joule to generate pulsed fluorescence in the sample;
receiving a portion of the pulsed fluorescence from the sample at a fluorescence wavelength-selector;
selecting a fraction of the fluorescence received at the fluorescence wavelength-selector that lies within a specified wavelength range using the fluorescence wavelength-selector and outputting fluorescence photons within the specified wavelength range from fluorescence wavelength-selector;
receiving the fluorescence photons within the specified wavelength range from the fluorescence wavelength-selector at a photodetector;
converting the fluorescence photons received by the photodetector into a time-dependent electrical signal using the photodetector and outputting the time-dependent electrical signal from the photodetector;
receiving the time-dependent electrical signal from the photodetector at a digitizer;
digitizing the time-dependent electrical signal;
recording the digitized time-dependent electrical signal as a wavelength-time matrix that includes fluorescence decay curves for at least two emission wavelengths; and
analyzing the wavelength-time matrix to determine a numerical value, wherein the numerical value represents the contribution of at least one fluorescent component to the data contained within the wavelength-time matrix.

70. The method of claim 69, wherein analyzing the wavelength-time matrix includes using reference wavelength-time matrices for target compounds.

71. The method of claim 70, wherein analyzing the wavelength-time matrix includes fitting the reference wavelength-time matrices to the wavelength-time matrix using a non-negative least squares method.

72. The method of claim 69, wherein analyzing the wavelength-time matrix includes representing the data contained within the wavelength-time matrix as a product of two matrices, such that one matrix contains information on the wavelength dependence of the fluorescence of chemical components in the sample and the other matrix contains information on the fluorescence decay properties of the chemical components in the sample.

73. A fluorometric method comprising:
irradiating a sample with a plurality of light pulses selectively at two or more excitation wavelengths to generate pulsed fluorescence in the sample, the light pulses at each excitation wavelength having a shot-to-shot fluctuation no greater than three percent;
selecting a portion of the pulsed fluorescence from the sample within a specified wavelength range;
generating a time-dependent electrical signal based on the selected portion of the pulsed fluorescence; and
determining a numerical value for the contribution of at least one component of the sample based on the time-dependent electrical signal.

74. The method of claim 73, wherein determining a numerical value includes generating fluorescence decay curves from the time-dependent electrical signal for at least two different excitation wavelengths, wherein the numerical value is determined from the fluorescence decay curves.

75. The method of claim 73, wherein determining a numerical value comprises:
digitizing the time-dependent electrical signal;
recording the digitized time-dependent electrical signal as a wavelength-time matrix that includes fluorescence decay curves for at least two excitation wavelengths; and
analyzing the wavelength-time matrix to determine the numerical value, wherein the numerical value represents the contribution of at least one fluorescent component to the data contained within the wavelength-time matrix.

76. A fluorometric method comprising:
irradiating a sample using a repetitively pulsed excitation light source that selectively outputs light pulses at various excitation wavelengths and that has a shot-to-shot fluctuation no greater than three percent at any of the excitation wavelengths to generate pulsed fluorescence in the sample;
receiving a portion of the pulsed fluorescence from the sample at a fluorescence wavelength-selector;
selecting a fraction of the fluorescence received at the fluorescence wavelength-selector that lies within a specified wavelength range using the fluorescence wavelength-selector and outputting fluorescence photons within the specified wavelength range from fluorescence wavelength-selector;
receiving the fluorescence photons within the specified wavelength range from the fluorescence wavelength-selector at a photodetector;
converting the fluorescence photons received by the photodetector into a time-dependent electrical signal using the photodetector and outputting the time-dependent electrical signal from the photodetector;
receiving the time-dependent electrical signal from the photodetector at a signal processor; and
determining a numerical value for the contribution of at least one component of the sample based on the time-dependent electrical signal using the signal processor.

77. The method of claim 76, wherein determining a numerical value includes generating fluorescence decay curves from the time-dependent electrical signal and storing the decay curves for at least two different excitation wavelengths, wherein the numerical value is determined from the stored decay curves.

78. The method of claim 76, wherein determining a numerical value comprises:
digitizing the time-dependent electrical signal;
recording the digitized time-dependent electrical signal as a wavelength-time matrix that includes fluorescence decay curves for at least two excitation wavelengths; and
analyzing the wavelength-time matrix to determine the numerical value, wherein the numerical value represents the contribution of at least one fluorescent component to the data contained within the wavelength-time matrix.

79. A fluorometric method comprising:
generating a series of light pulses using a single-mode input pulsed laser;
receiving the light pulses at an excitation wavelength-converter;
selecting light pulses at various wavelengths using the excitation wavelength-converter and outputting the light pulses at the selected excitation wavelengths from the excitation wavelength-converter, the light pulses having a shot-to-shot fluctuation no greater than one percent at any of the excitation wavelengths;
irradiating a sample with the light pulses output from the excitation wavelength-converter to generate pulsed fluorescence in the sample;
receiving a portion of the pulsed fluorescence from the sample at a fluorescence wavelength-selector;
selecting a fraction of the fluorescence received at the fluorescence wavelength-selector that lies within a specified wavelength range using the fluorescence wavelength-selector and outputting fluorescence photons within the specified wavelength range from fluorescence wavelength-selector;
receiving the fluorescence photons within the specified wavelength range from the fluorescence wavelength-selector at a photodetector;
converting the fluorescence photons received by the photodetector into a time-dependent electrical signal using the photodetector and outputting the time-dependent electrical signal from the photodetector;
receiving the time-dependent electrical signal from the photodetector at a digitizer;
digitizing the time-dependent electrical signal;
recording the digitized time-dependent electrical signal as a wavelength-time matrix that includes fluorescence decay curves for at least two excitation wavelengths; and
analyzing the wavelength-time matrix to determine a numerical value, wherein the numerical value represents the contribution of at least one fluorescent component to the data contained within the wavelength-time matrix.

80. The method of claim 79, wherein analyzing the wavelength-time matrix includes using reference wavelength-time matrices for target compounds.

81. The method of claim 80, wherein analyzing the wavelength-time matrix includes fitting the reference wavelength-time matrices to the wavelength-time matrix using a non-negative least squares method.

82. The method of claim 79, wherein analyzing the wavelength-time matrix includes representing the data contained within the wavelength-time matrix as a product of two matrices, such that one matrix contains information on the wavelength dependence of the fluorescence of chemical components in the sample and the other matrix contains information on the fluorescence decay properties of the chemical components in the sample.

83. The method of claim 79, wherein selecting light pulses at various wavelengths using the excitation wavelength-converter includes:
generating photons simultaneously at multiple wavelengths at the excitation wavelength-converter; and
transmitting the photons at the multiple wavelengths to a excitation wavelength-selector.
